(19) United States
(12) Patent Application Publication
(10) Pub. No.: US 2008/0046641 A1
(43) Pub. Date: Feb. 21, 2008

(54) NAND flash memory controller exporting a logical sector-based interface

(75) Inventor: Menahem Lasser, Kohav Yair (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD.

(21) Appl. No.: 11/806,701

(22) Filed: Jun. 4, 2007

Related U.S. Application Data
(60) Provisional application No. 60/822,948, filed on Aug. 21, 2006.

(51) Int. Cl. G06F 12/00

(52) U.S. Cl. 711/103; 711/E12.002

(57) ABSTRACT

A controller of a flash memory device exchanges data pages with the memory device via a host-type NAND interface and exchanges data sectors with a host via a flash-type NAND interface. The data sectors are different in size than the data pages. A data storage system includes the controller and the memory device. Another data storage system includes a memory whose physical pages have a common size and circuitry for exporting a flash-type NAND interface for exchanging data sectors, that differ in size from the physical pages, with a host. A data processing system includes the data storage system and the host.

This patent application claims the benefit of U.S. Provisional Patent Application No. 60/822,948, filed Aug. 21, 2006 This application is related to U.S. patent application Ser. No. 11/______ of the same inventors, which is entitled “A NAND FLASH MEMORY CONTROLLER EXPORTING A LOGICAL SECTOR-BASED INTERFACE” and filed on the same day as the present application. The latter application, also claiming priority from U.S. Provisional Patent Application No. 60/60/822,948, is incorporated in its entirety as if fully set forth herein.

### FIELD AND BACKGROUND OF THE INVENTION

The present invention relates to memory devices such as flash memory devices and, more particularly, to a memory device whose controller exports a logical sector-based interface.

Flash memory devices have been known for many years. Typically, each cell within a flash memory stores one bit of information. Traditionally, the way to store a bit has been by supporting two states of the cell—one state represents a logical “0” and the other state represents a logical “1”. In a flash memory cell the two states are implemented by having a floating gate above the cell's channel (the area connecting the source and drain elements of the cell's transistor), and having two valid states for the amount of charge stored within this floating gate. Typically, one state is with zero charge in the floating gate and is the initial unwritten state of the cell after being erased (commonly defined to represent the “1” state) and another state is with some amount of negative charge in the floating gate (commonly defined to represent the “0” state). Having negative charge in the gate causes the threshold voltage of the cell's transistor (i.e. the voltage that has to be applied to the transistor's control gate in order to cause the transistor to conduct) to increase. Now it is possible to read the stored bit by checking the threshold voltage of the cell—if the threshold voltage is in the higher state then the bit value is “0” and if the threshold voltage is in the lower state then the bit value is “1”. Actually there is no need to accurately read the cell's threshold voltage—all that is needed is to correctly identify in which of the two states the cell is currently located. For that purpose it suffices to make a comparison against a reference voltage value that is in the middle between the two states, and thus to determine if the cell's threshold voltage is below or above this reference value.

FIG. 1A shows graphically how this works. Specifically, FIG. 1A shows the distribution of the threshold voltages of a large population of cells. Because the cells in a flash device are not exactly identical in their characteristics and behavior (due, for example, to small variations in impurity concentrations or to defects in the silicon structure), applying the same programming operation to all the cells does not cause all of the cells to have exactly the same threshold voltage. (Note that, for historical reasons, writing data to a flash memory is commonly referred to as “programming” the flash memory. The terms “writing” and “programming” are used interchangeably herein.) Instead, the threshold voltage is distributed similar to the way shown in FIG. 1A. Cells storing a value of “1” typically have a negative threshold voltage, such that most of the cells have a threshold voltage close to the value shown by the left peak of FIG. 1A, with some smaller numbers of cells having lower or higher threshold voltages. Similarly, cells storing a value of “0” typically have a positive threshold voltage, such that most of the cells have a threshold voltage close to the value shown by the right peak of FIG. 1A, with some smaller numbers of cells having lower or higher threshold voltages.

In recent years a new kind of flash device has appeared on the market, using a technique conventionally called “Multi Level Cells” or MLC for short. (This nomenclature is misleading, because the previous type of flash cells also has more than one level: they have two levels, as described above. Therefore, the two kinds of flash cells are referred to herein as “Single Bit Cells” (SBC) and “Multi-Bit Cells” (MBC).) The improvement brought by the MBC flash is the storing of two bits in each cell. (In principle MBC also includes the storage of more than two bits per cell. In order to simplify the explanations, the two-bit case is emphasized herein. It should however be understood the present invention is equally applicable to flash memory devices that support more than two bits per cell.) In order for a single cell to store two bits of information the cell must be able to be in one of four different states. As the cell's “state” is represented by its threshold voltage, it is clear an MBC cell should support four different valid ranges for its threshold voltage. FIG. 1B shows the threshold voltage distribution for a typical MBC cell. As expected, FIG. 1B has four peaks, each corresponding to one of the states. As for the SBC case, each state is actually a range of threshold voltages and not a single threshold voltage. When reading the cell's contents, all that must be guaranteed is that the range that the cell's threshold voltage is in is correctly identified. For a prior art example of an MBC flash device see U.S. Pat. No. 5,434,825 to Harari, which patent is incorporated by reference for all purposes as if fully set forth herein.

Flash memory devices are typically divided into NOR devices and NAND devices, the names being derived from the way the individual memory cells are interconnected within the cells array. NOR devices are random access—a host computer accessing a NOR flash device can provide the device any address on the device's address pins and immediately retrieve data stored in that address on the device's data pins. This is much like how SRAM or EPROM memories operate. NAND devices, on the other hand, are not random access devices but rather serial access devices. It is not possible to access any random address in the way described above for NOR—instead the host has to write into the device a sequence of bytes which identifies both the type of the requested command (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. It is true that the read and write command sequences include addresses of single bytes or words, but in reality the NAND flash device always reads entire pages from the memory cells and writes entire pages to the memory cells. After a page of data has been read from the array into a buffer inside the device, the host can access the data bytes or words one by one by serially clocking them out using a strobe signal.

Because of the non-random access nature of NAND devices, such devices cannot be used for running code directly from their flash memories. This is in contrast to NOR devices, that support direct code execution (typically called “eXecution In Place” or “XIP”). Therefore NOR devices are the devices typically used for code storage. However, NAND devices have advantages that make them very useful for data storage. NAND devices are cheaper than NOR devices of the same bit capacity, or equivalently—NAND devices provide many more bits of storage than NOR devices for the same cost. Also, the write and erase performance of NAND devices is much faster than the write and erase performance of NOR devices. These advantages make NAND flash memory technology the technology of choice for storing data.

One typical SBC NAND device is the TC58NVG1S3B, of Toshiba Corporation, Tokyo, Japan, that provides 2 Gbit of storage. A typical MBC NAND device is the TC58NVG2D4B, also of Toshiba Corporation, Tokyo, Japan, that provides 4 Gbit of storage. The data sheets of both devices are attached as Appendix A and Appendix B.

As can be seen from the aforementioned data sheets, those two NAND devices have similar interfaces. These NAND devices use the same electrical signals for coordinating commands and data transfer between the NAND flash devices and their host devices. Those signals include data lines and a few control signals—ALE (Address Latch Enable), CLE (Command Latch Enable), WE (Write Enable), RE\ (Read Enable), and more. The SBC and MBC devices are not fully identical in their behavior—the time it takes to write an MBC page is much longer than time it takes to write an SBC page. However, the electrical signals used in both devices and the functionalities of the two devices are the same. This type of interface protocol is known in the art as a “NAND interface” protocol. Even though the “NAND interface” protocol has not, to date, been formally standardized by a standardization body, the manufacturers of NAND flash devices all follow the same protocol for supporting the basic subset of NAND flash functionality. This is done so that customers using NAND devices within their electronic products can use NAND devices from any manufacturer without having to tailor their hardware or software for operating with the devices of a specific vendor. It is noted that even NAND vendors that provide extra functionality beyond this basic subset of functionality ensure that the basic functionality is provided in order to provide compatibility with the protocol used by the other vendors, at least to some extent.

Herein the term “NAND Interface protocol” (or “NAND interface” in short) means an interface protocol between an initiating device and a responding device that in general follows the protocol described above between a host device and a NAND flash device for basic read and write operations, even if the protocol is not fully compatible with all timing parameters, does not support an erase command, is not fully compatible with respect to other commands supported by NAND devices, or contains additional commands not supported by NAND devices. In other words, the term “NAND interface (protocol)” refers to any interface protocol that uses sequences of transferred bytes equivalent in functionality to the sequences of bytes used when interfacing with the Toshiba TC58NVG1S3B NAND device and the Toshiba TC58NVG2D4B NAND device for reading (opcode 00H) and writing (opcode 80H), and also uses control signals equivalent in functionality to the CLE, ALE, CE, WE and RE signals of these two NAND devices.

It should be noted that the “NAND interface protocol” is not symmetric. It is always the host device that initiates the interaction over a NAND interface, and never the flash memory device.

A given device (e.g. a controller, flash device, host device, etc.) is said to comprise, include or have a “NAND interface” if the device includes elements (e.g. hardware, software, firmware or any combination thereof) necessary for supporting the NAND interface protocol (e.g. for interacting with another device using the NAND interface protocol).

Because the NAND interface protocol is not symmetric, the terms “host-type NAND interface” and “flash-type NAND interface” are used herein to differentiate between the two sides of a NAND interface protocol=. Because it is always the host that initiates the interaction, a given device is said to have a “host-type NAND interface” or to export a “host-type NAND interface” or to “support” a “host-type NAND interface” if the device includes the necessary hardware and/or firmware and/or software for implementing the host side of the NAND interface protocol (i.e. for presenting a NAND host, and initiating the NAND protocol interaction) Similarly, because the flash device never initiates the interaction, a given device is said to have a “flash-type NAND interface” or to “export” a “flash-type NAND interface” or to “support” a “flash-type NAND interface” if the device includes the necessary hardware and/or firmware and/or software for implementing the flash side of the NAND protocol (i.e. for presenting a NAND flash device).

Herein the term “host device” (or “host” in short) means any device that has processing power and is capable of interfacing with a flash memory device. Examples of typical host devices include personal computers, PDAs, cellular phones, game consoles, etc.

Typically, NAND devices are relatively difficult to interface and work with. One reason for that is the relatively complex (compared to NOR devices) protocol for accessing NAND devices, as described above. Another difficulty is the existence of errors in the data read from NAND devices, in contrast to NOR devices that can be assumed to always return correct data. This inherent non-reliability of NAND devices requires the use of Error Detection Codes (EDC) and Error Correction Codes (ECC).

Manufacturers of SBC NAND flash devices typically advise users to apply an Error Correction Code capable of correcting 1 bit error in each page of 512 bytes of data. But data sheets of MBC NAND flash devices typically advise applying an ECC capable of correcting 4 bit errors in each page of 512 bytes of data. For pages of size 2048 bytes such as in the case of the NAND devices mentioned above (known as “large block devices”), the suggestion is to apply error correction per each portion of 512 bytes of the page. Herein the term “N-bit ECC” refers to an ECC scheme capable of correcting N bit errors in 512 bytes of data, regardless of whether the 512 bytes are the size of one page, smaller than one page, or larger than one page.

Because of these complexities of NAND devices, it is the common practice to use a “NAND controller” for controlling the use of a NAND device in an electronic system. It is true that it is possible to operate and use a NAND device directly by a host device with no intervening NAND controller, and there are systems that actually operate like this. However, such an architecture suffers from many disadvantages. First, the host has to individually manipulate each one of the NAND device's control signals (e.g. CLE or ALE), which is cumbersome and time-consuming for the host. Second, the support of EDC and ECC puts a severe burden on the host—parity bits have to be calculated for each page written, and error detection calculations (and sometimes also error correction calculations) must be performed by the host. All this makes such “no controller” architecture relatively slow and inefficient.

Using a NAND controller significantly simplifies the host's tasks when using the NAND device. The processor interacts with the controller using a protocol that is much more convenient to use—a request for writing a page may be sent as a single command code followed by address and data, instead of having to bother with the complex sequencing of control lines and NAND command codes. The controller then converts the host-controller protocol into the equivalent NAND protocol sequences, while the host is free to do other tasks (or just to wait for the NAND operation to finish, if so desired).

There are several options in the prior art regarding the location of the NAND controller within the system. A first approach is shown in FIG. 2. Here a NAND controller 114 is physically located within a host processor 112A of a host device 110A. If host processor 112A is implemented as a single die, then controller 114 is incorporated on the same die. This is for example the case in some of the OMAP processors manufactured and sold by Texas Instruments of Dallas Tex. USA. In a system built using this architecture host processor 112A typically interacts with NAND controller 114 using some proprietary protocol, as the interaction is internal to host processor 112A and there is no benefit in using a standard protocol.

A second prior art approach is shown in FIGS. 3A-3B. Here a NAND controller 116 is a separate physical element, residing between a host processor 112B of a host 110B and a NAND device 120A. This is for example the case in portable USB Flash Drives (UFDs), such as the DiskOnKey manufactured and sold by SanDisk Corporation of Milpitas CA USA. In such a UFD there is a NAND controller 116 packaged inside the UFD and interacting with NAND device 120A using a device side NAND interface 124 on one side and with host processor 112B on the other side (using a host side USB interface 122 that uses the USB protocol). In a system built using this architecture host processor 112B typically interacts with NAND controller 116 using a standard protocol such as USB or ATA, as the interaction is external to processor 112B and it is more convenient to use standard protocols that are already supported by processor 112B for other purposes.

A third prior art approach is shown in FIG. 4. Here a NAND controller 118 is physically located within a NAND device 120B. NAND device 120B and controller 118 may even be implemented on the same die. This is for example the case in some of the MDOC storages devices manufactured and sold by SanDisk Corporation and in the OneNAND devices manufactured and sold by Samsung Electronics of Suwon, South Korea. In a system built using this architecture host processor 112B typically interacts with NAND controller 118 using either a standard protocol such as USB or a semi-standard protocol as is the case in the MDOC and OneNAND devices.

It can be deduced from the above that a prior art stand-alone NAND controller (that is not integrated with either the NAND device or the host processor) typically has a standard interface on its host side and a NAND interface on its flash memory device side, as in FIG. 3B. Indeed one can find in the market NAND controllers exporting many interface types—USB, SD (SecureDigital), MMC (MultiMediaCard), and others. U.S. patent application Ser. No. 11/326,336, to Lasser, published as US Patent Application Publication No. 2007/0074093, discloses a NAND controller that has a NAND-type interface on both sides.

Another function provided by NAND controllers is the exporting to the host of a logical address space rather than a physical address space. Flash devices have certain limitations that make using these devices at the physical address level a bit of a problem. In a flash device, it is not practical to rewrite a previously written area of the memory without a prior erase of the area, i.e. flash cells must be erased (e.g. programmed to “one”) before the cells can be programmed again. Erasing can only be done for relatively large groups of cells usually called “erase blocks” (typically of size 16 to 128 Kbytes in current commercial NAND devices, and of larger size in NOR devices). Therefore updating the contents of a single byte or even of a chunk of 1 kilobytes requires “housekeeping” operations—parts of the erase block that are not updated must first be moved elsewhere so these parts will be preserved during erasing, and then moved back into place.

Furthermore, some of the blocks of the device are “bad blocks” that are not reliable, so that the use of these blocks should be avoided. Blocks are declared as “bad blocks” either by the manufacturer when initially testing the device or by application software when detecting the failure of the blocks during use of the device in the field.

To overcome these limitations of the NAND devices, Flash File Systems (FFS) have been introduced. One such FFS is described in U.S. Pat. No. 5,404,485 to Ban, which is incorporated by reference as if fully set forth herein. A FFS provides a system of data storage and manipulation on flash devices that allows these devices to emulate magnetic disks. In the existing art, applications or operating systems interact with a flash storage system not using physical addresses but rather using logical addresses (sometimes called virtual addresses). There is an intermediary software layer between the software application and the physical storage system that provides a mapping from the logical addresses into the physical addresses. While the software may view the storage system as having a contiguous defect-free medium that can be read or written randomly with no limitations, the physical addressing scheme has “holes” in its address range (due to bad blocks, for example), and pieces of data that are adjacent to each other in the logical address range might be greatly separated in the physical address range. The intermediary software layer that does the mapping described above may be a software driver running on the same CPU on which the applications run. Alternatively, the intermediary software layer may be embedded within a controller that controls the flash device of the storage system and serves as the interface for the main CPU of the host computer when the host computer accesses the storage system. This is for example the situation in removable memory cards such as SecureDigital (SD) cards or MultiMediaCards (MMC), in which the card has an on-board controller running a firmware program that, among other functions, implements this type of mapping.

Software or firmware implementations that do such address mappings are typically called “flash management systems” or “flash file systems”. The latter term is a misnomer, as the implementations do not necessarily support “files”, in the sense that files are used in operating systems or personal computers, but rather support block device interfaces similar to those exported by hard disk software drivers. Nevertheless, the term “flash file sysem” is commonly used, and “flash file system” and “flash management system” are used herein interchangeably.

Other prior art systems that implement logical-to-physical address mapping are described in U.S. Pat. No. 5,937,425 to Ban and in U.S. Pat. No. 6,591,330 to Lasser, both of which patents are incorporated by reference for all purposes as if fully set forth herein.

A storage device is said herein to export (or simply to “have”) a logical interface if a host computer interfacing with that device and accessing the device for reading and/or writing data is not aware of the physical addresses at which the data 15 are stored. The data written/read to/from a specific logical address provided by the host might be stored in any physical location within the storage device, but this fact is invisible to the host. Typically, that a storage device has a logical interface also means that the host sees the storage device as having a contiguous “holes-free” address space.

A storage device is said herein to export (or to “have”) a physical interface if a host computer interfacing with that device and accessing the device for reading and/or writing data is aware of the physical addresses at which the data are stored, and explicitly refers to such physical addresses when issuing commands to the storage device.

More generally, a device that “has” or “exports” a flash-type NAND interface is said herein to “have” or “export” a “logical” flash-type NAND interface if, as in the case of a storage device that has a logical interface, the corresponding host device that interacts with the device via its host-type NAND interface is not aware of physical addresses but only of logical addresses. The corresponding host-type interface of the host device is said herein to be a “logical” host-type NAND interface. Similarly, a device that “has” or “exports” a flash-type NAND interface is said herein to “have” or “export” a “physical” host-type NAND interface if, as in the case of a storage device that has a physical interface, the corresponding host device is aware of physical addresses. The corresponding host-type interface of the host device is said herein to be a “physical” host-type NAND interface. Note that a logical flash-type NAND interface of one device must be paired with a logical host-type NAND interface of another device for the two devices to exchange data according to a NAND protocol; and a physical flash-type NAND interface of one device must be paired with a physical host-type NAND interface of another device for the two devices to exchange data according to a NAND protocol.

Using the above terminology, the prior art NAND flash devices may be classified as follows:

A. Devices that export to their hosts an interface that is not a NAND interface and is a logical interface. All devices exporting USB, SD or MMC interfaces fall within this class, as those protocols (that all use non-NAND interfaces) require the use of logical addresses.

B. Devices that export to their hosts a NAND interface that is a logical interface. Such is for example the controller disclosed in Lasser, U.S. Ser. No. 11/326,336.

C. Devices that export to their hosts a NAND interface that is a physical interface. Standard NAND devices such as the two Toshiba NAND devices mentioned above fall within this class.

There is one further issue of potential complexity in interfacing with NAND-based flash memory devices that must be addressed. NAND devices are written in pages. In other words, a page is the smallest chunk of data that can be written into the memory cells array. In the past most NAND flash devices used pages of 0.5 Kbytes (512 bytes). Recently most NAND devices use pages of 2 Kbytes. On the other hand, operating systems of host computers and applications executing on host computers typically access stored data in units of “sectors” that are 0.5 Kbytes large. When using NAND devices with 0.5 Kbyte pages, there is an exact match between page size and sector size, and no difficulty is expected. However, when using NAND devices with 2 Kbytespages (or other page sizes that are larger than a sector's size), multiple sectors are assigned to a common flash page, and this creates some complexities, as will be explained below.

U.S. Pat. No. 6,760,805 to Lasser explains some of the complexities associated with flash management systems when page size is larger than sector size, and teaches methods for solution of these problems. The methods of U.S. Pat. No. 6,760,805 deal with the way physical addresses are allocated by the flash management system, and are not directly related to logical addresses known by the host.

Storage devices that export a non-NAND interface (such as USB, SD or MMC) use sectors as their basic unit of data transfer. Therefore when using such devices the host does not have to be aware of the actual page size within the device and the controller takes care of all conversions and mappings. This is reasonable to expect, as such controllers already handle logical-to-physical address translation, and adding the sectors-to-pages mapping is a natural extension. When using storage devices that export a NAND interface that is also a physical interface the basic unit of data transfer between the host and the memory device is the page. If the page is larger than a sector, the burden of mapping and matching data sectors to pages falls on the host.

One would expect that when using a storage device that has a NAND interface that is a logical interface, the unit of data transfer would be a sector, as the use of logical addressing implies the existence of logical-to-physical address translation, to which the sectors-to-pages mapping can easily be added. However, this is not the case—all prior art devices that have a NAND interface that is a logical interface use pages and not sectors as their basic unit of data transfer.

This fact eliminates much of the benefit that is to be gained by using logical NAND interfaces. The advantage of such interfaces, and the main reason for their adoption, is to simplify the access software on the host side. As the logical interface takes care of bad blocks and other headaches of flash management, the access by the host to the memory device becomes very simple—the host writes a logical page and reads a logical page. No concern needs to be given to the physical location of a page or to garbage collection tasks that must be done in order to have enough free space for additional writing. But if a NAND-type logical interface uses pages as its basic unit of data transfer and the page size is different than the sector size, much of this simplicity is gone.

To see why this is so consider what happens when a host has to write a stream of several 0.5 Kbyte logical sectors into a device exporting page operations of 2 Kbytes each. Let us assume as an example that that the sectors having logical addresses 0, 1, 2 and 3 are to be written into the storage device, one by one. As the interface supports only 2 Kbytes page operations, when writing sector No. 0 the host actually causes 2 Kbytes to be moved into the flash array of cells. Then sector No. 1 should be written. But that sector has to be packed into a common page with sector No. 0. So the host must read back sector 0, merge the data of both sectors, and send a page write command containing the data of both sectors. This continues with sector No. 2 and then also with sector No. 3. In each case previous sectors have to be read out to the host, only to be written again after being combined by the host with the newly arriving sector. This process is highly inefficient and, as stated above, eliminates the main advantage of having a logical interface in the first place—accessing the memory device according to a simple access model without the host having to be bothered by physical implementation details of the flash memory, such as page size.

There is thus a widely recognized need for, and it would be highly advantageous to have, a convenient way to access a storage device that has a logical NAND interface even by a host whose sector size is different from the page size of the storage device.

### SUMMARY OF THE INVENTION

According to the present invention there is provided a controller for a flash memory device, including: (a) a host-type NAND interface for exchanging data pages with the NAND flash memory device; and (b) a flash-type NAND interface for exchanging data sectors with a host of the controller; wherein the data pages have a common data page size, and wherein the data sectors have a common data sector size different than the common data page size.

According to the present invention there is provided a data storage system including: (a) a memory that includes a plurality of physical pages having a common physical page size; and (b) circuitry for exporting a flash-type NAND interface for exchanging data sectors with a host of the data storage system, wherein the data sectors have a common data sector size different than the physical page size.

According to the present invention there is provided a method of storing data, including the steps of: (a) providing a memory that includes a plurality of physical pages having a common physical page size; and (b) exporting, to a host, a flash-type NAND interface for exchanging data sectors with the host, wherein the data sectors have a common data sector size that is different than the physical page size.

A basic controller of the present invention, for controlling a flash memory device, includes a host-type NAND interface for exchanging data pages with the flash memory device and a flash-type NAND interface for exchanging data sectors with a host of the controller. The data pages have a common data page size, the data sectors have a common data sector size, and the common data sector size is different than the common data page size. The “size” of a data page is understood herein to be the number of bits in a data page. The “size” of a data sector is understood herein to be the number of bits in a data sector. For example, using bytes that are eight bits long, the size of a 512-byte sector is 4096 bits and the size of a 2-Kbyte page is 16,384 bits. Preferably, the common data sector size is smaller than the common data page size.

Preferably, the host-type NAND interface is a physical interface and the flash-type NAND interface is a logical interface.

Preferably, the controller also includes at least one host-side interface. Note that a “host-side” interface is not the same as a “host-type” interface. For example, FIG. 5A below shows a controller with two host-side interfaces, one of which is a flash-type interface.

Preferably, the controller also includes one or more functional modules such as an error correction module, an encryption module and/or an address mapping module.

One type of data storage system of the present invention includes a controller of the present invention and the flash memory device that the controller controls. Preferably, the flash memory device is a NAND flash memory device.

Options for fabricating the controller and the flash memory device include fabricating the controller and the flash memory device on different respective dies, in which case the host-type NAND interface is an inter-die interface, and fabricating the controller and the flash memory device on a common die. If the controller and the flash memory device are fabricated on different dies, the packaging option include: packaging both the controller and the flash memory device in the same multi-chip package; packaging the controller in a controller package while packaging the flash memory device in a separate memory device package; packaging the controller in a controller package while mounting the flash memory device die directly on a printed circuit board; packaging the flash memory device in a memory device package while mounting the controller die directly on a printed circuit board; and mounting both the controller die and the flash memory device die directly on a printed circuit board.

One type of data processing system of the present invention includes such a data storage system and a host thereof.

Another basic data storage system of the present invention includes a memory that includes a plurality of physical pages that all have a common physical page size. Such a basic data storage system also includes circuitry for exporting a flash-type NAND interface for exchanging data sectors with a host of the data storage system. The data sectors have a common data sector size that is different than the common physical page size of the pages of the memory. The “size” of a physical page is understood herein to be the maximum number of bits that can be stored in a physical page. For example, using bytes that are eight bits long, the size of a 2-Kbyte physical page is 16,384 bits. Preferably, the common data sector size is smaller than the common physical page size.

Preferably, the flash-type NAND interface is a logical interface.

Preferably, each page includes a plurality of flash cells. Most preferably the flash cells are NAND flash cells.

Options for fabricating the circuitry and the memory include fabricating the circuitry and the memory on different respective dies and fabricating the circuitry and the memory on a common die. If the circuitry and the memory are fabricated on different dies, the packaging option include: packaging both the circuitry and the memory in the same multi-chip package; packaging the circuitry in a circuitry package while packaging the memory in a separate memory package; packaging the circuitry in a circuitry package while mounting the memory die directly on a printed circuit board; packaging the memory in a memory package while mounting the circuitry die directly on a printed circuit board; and mounting both the circuitry die and the memory die directly on a printed circuit board.

Another data processing system of the present invention includes such a data storage system and a host of such a data storage system.

A basic method of the present invention for storing data includes the step of providing a memory that includes a plurality of physical pages that all have a common physical page size and the step of exporting, to a host, a flash-type NAND interface for exchanging data sectors with the host. The data sectors have a common data sector size that is different than the common physical page size of the pages of the memory. Preferably, the common data sector size is smaller than the common physical page size.

Preferably, each physical page has a respective range of physical addresses and each data sector has a respective logical sector address. Data are written to the memory by steps including: receiving, from the host, one or more data sectors to write to the memory; mapping the logical sector address of each received data sector into a corresponding physical address; and writing the data sector(s) to one or more physical pages that have, in their respective ranges of physical addresses, the physical address(es) to which the logical sector address(es) has/have been mapped. Data are read from the memory by steps including: receiving, from the host, a command to read one or more data sectors from the memory; mapping the logical sector address of each data sector into a corresponding physical address; and reading the data sector(s) from one or more physical pages that have, in their respective ranges of physical addresses, the physical address(es) to which the logical sector address(es) has/have been mapped.

### BRIEF DESCRIPTION OF THE DRAWINGS

The invention is herein described, by way of example only, with reference to the accompanying drawings, wherein:

FIG. 1A illustrates the threshold voltage distributions of flash cells programmed in l-bit mode;

FIG. 1B illustrates the threshold voltage distributions of flash cells programmed in 2-bit mode;

FIG. 2 is a high-level schematic block diagram of a prior art data processing system in which a controller of a flash memory device is included in a host of the flash memory device;

FIGS. 3A and 3B are high-level schematic block diagrams of a prior art data processing system in which a controller of a flash memory device is separate from both a host of the flash memory device and the flash memory device;

FIG. 4 is a high-level schematic block diagram of a prior art data processing system in which a controller of a flash memory device is included in the flash memory device;

FIG. 5A is a high-level schematic block diagram of a controller of the present invention;

FIG. 5B is a high-level schematic block diagram of a data processing system that includes the controller of FIG. 5A;

FIGS. 6A-6G illustrate various options for packaging the components of the data processing system of FIG. 5B;

FIG. 7 is a flow chart of writing data to a memory according to the present invention;

FIG. 8 is a flow chart of a method of reading data from a memory according to the present invention.

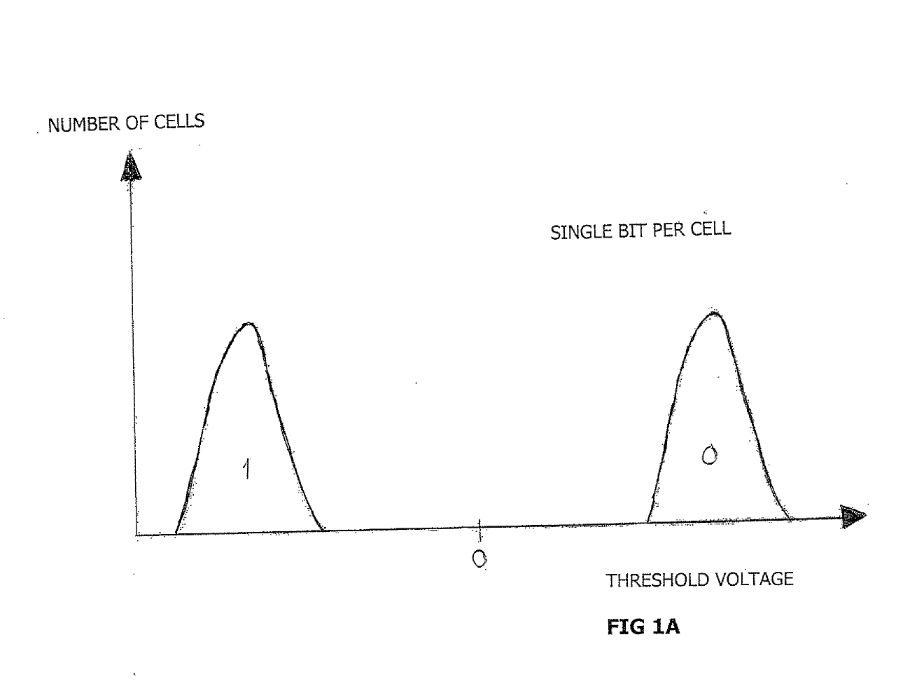

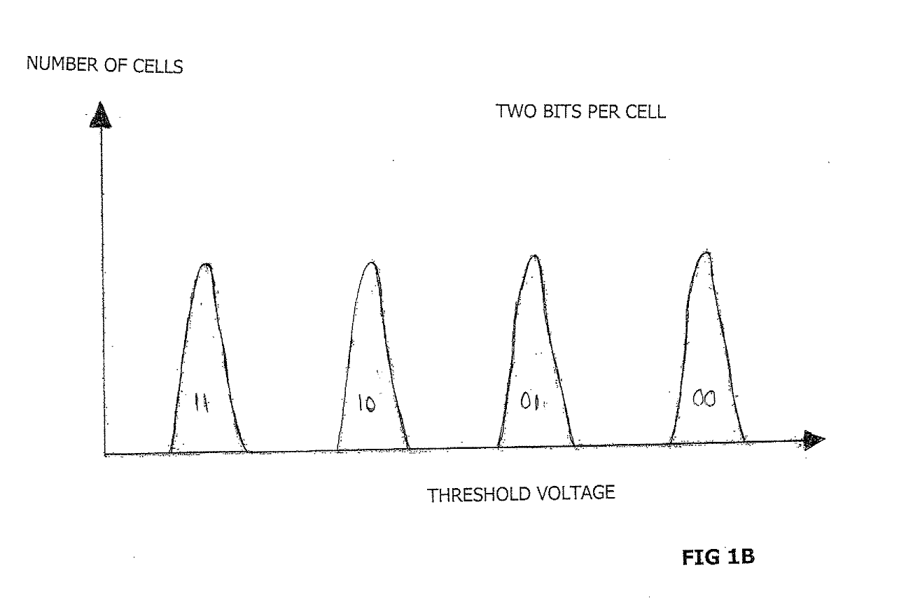

### DESCRIPTION OF THE PREFERRED EMBODIMENTS

The principles and operation of access to a memory device via a NAND interface according to the present invention may be better understood with reference to the drawings and the accompanying description.

The present invention will now be described in terms of specific exemplary embodiments. It is to be understood that the invention is not limited to the exemplary embodiments described below. It should also be understood that not every feature of the controllers, systems including controllers, and methods of reading and data described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The controller of the present invention is a NAND controller that exports to the host side a logical NAND interface that supports sectors as units of data transfer even though the physical pages of the NAND device controlled by the controller have different size than sector size. The controller of the present invention handles the mapping of logical sectors as seen by a host into physical pages as seen by a NAND device.

A “NAND flash memory device” is defined herein as electronic circuitry including a plurality of NAND flash memory cells and any necessary control circuitry (e.g. circuitry for providing a flash-type interface) for storing data within the NAND flash memory cells. It is noted that the “NAND flash memory device” does not necessarily have its own dedicated housing, and may reside with another “device” such as a controller within a single housing. In some embodiments of the present invention, the “NAND flash memory device” is directly mounted onto a printed circuit board without any intervening packaging.

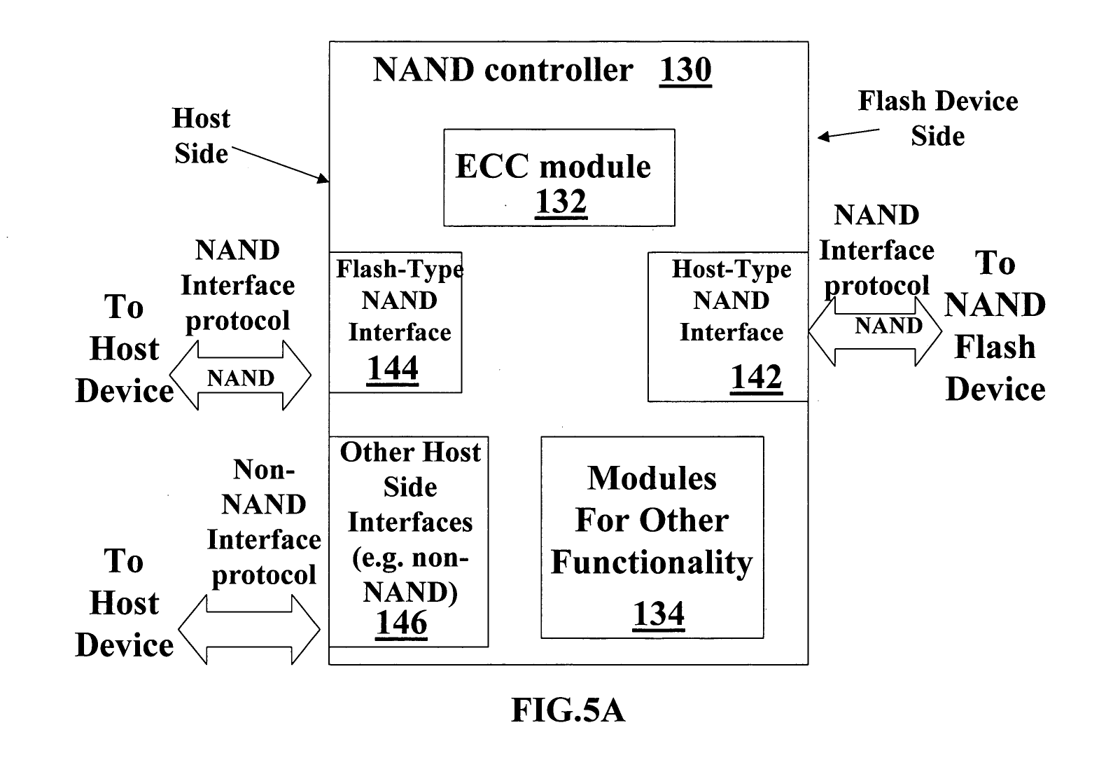

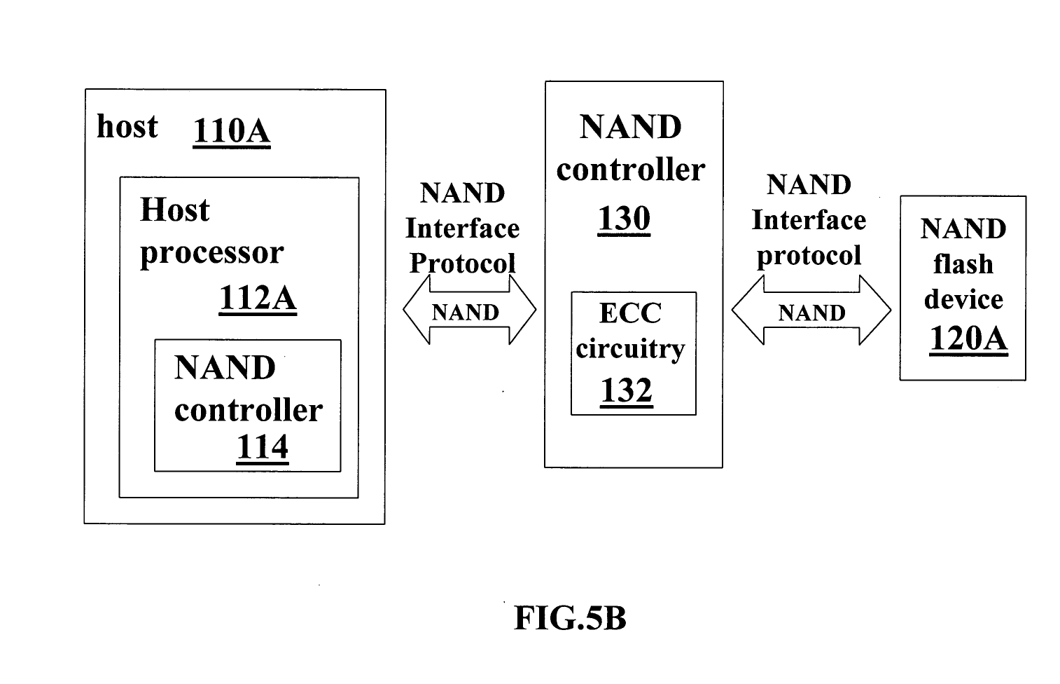

Referring again to the drawings, FIG. 5A is a schematic block diagram of a controller 130 in accordance with some embodiments of the present invention. Controller 130 includes a flash memory device-side NAND interface 142 for interfacing to a NAND flash device. Flash memory device-side NAND interface 142 is a host-type NAND interface (i.e. adapted to initiate the interaction over the NAND interface, and to present a host device to a NAND flash device).

Controller 130 also includes a host side NAND interface 144 for interfacing to a host that supports a NAND interface protocol. Host side NAND interface 144 is a flash memory-type NAND interface (i.e. controller 130 is adapted to present to the host a NAND flash memory storage device). The controller may optionally include one or more additional host-side interfaces 146 for interfacing the controller to hosts using non-NAND interfaces, such as USB or MMC interfaces.

As shown in FIG. 5A, controller 130 further includes an ECC module 132 for detecting and correcting all or some of the errors in the data retrieved from the NAND device through device-side interface 142. ECC module 132 may include hardware, software, firmware or any combination thereof. ECC module 132 may correct all errors, in which case NAND controller 130 exports to the host an error-free NAND device. Alternatively, ECC module 132 may correct only some of the errors found in the data retrieved from the NAND device through flash memory device-side NAND interface 142.

NAND controller 130 also includes one or more modules 134 (e.g. including hardware, software, firmware or any combination thereof) for providing other functionality, such as encryption functionality or address mapping that maps logical flash addresses received from the host into physical flash addresses sent to the flash device. As controller 130 exports a logical interface, controller 130 must include at least the functionality of logical-to-physical address translation. Other functionalities are optional.

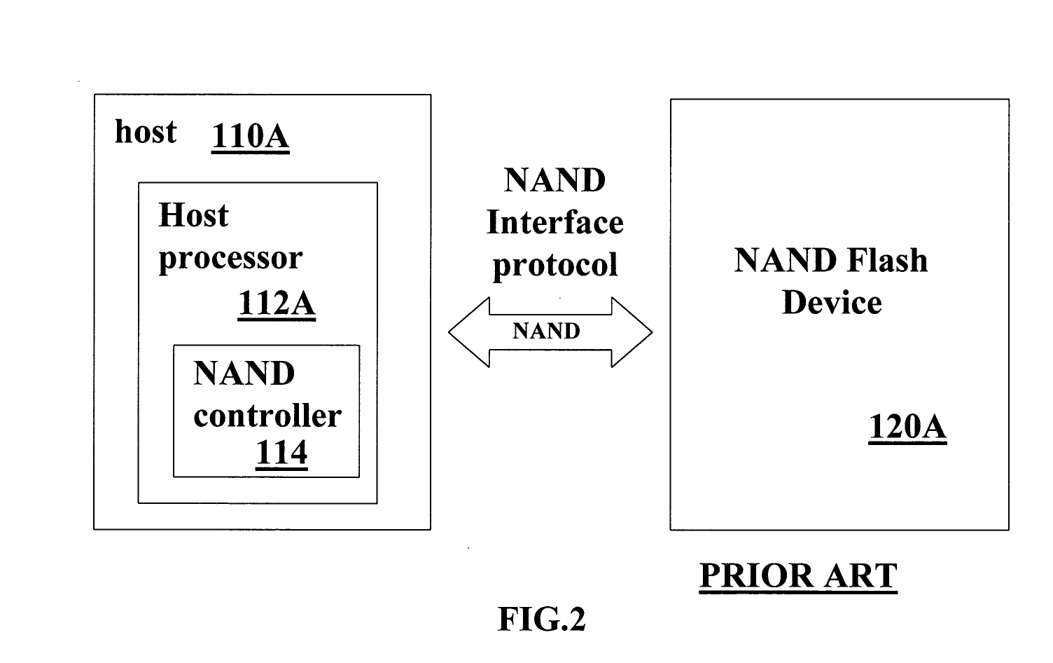

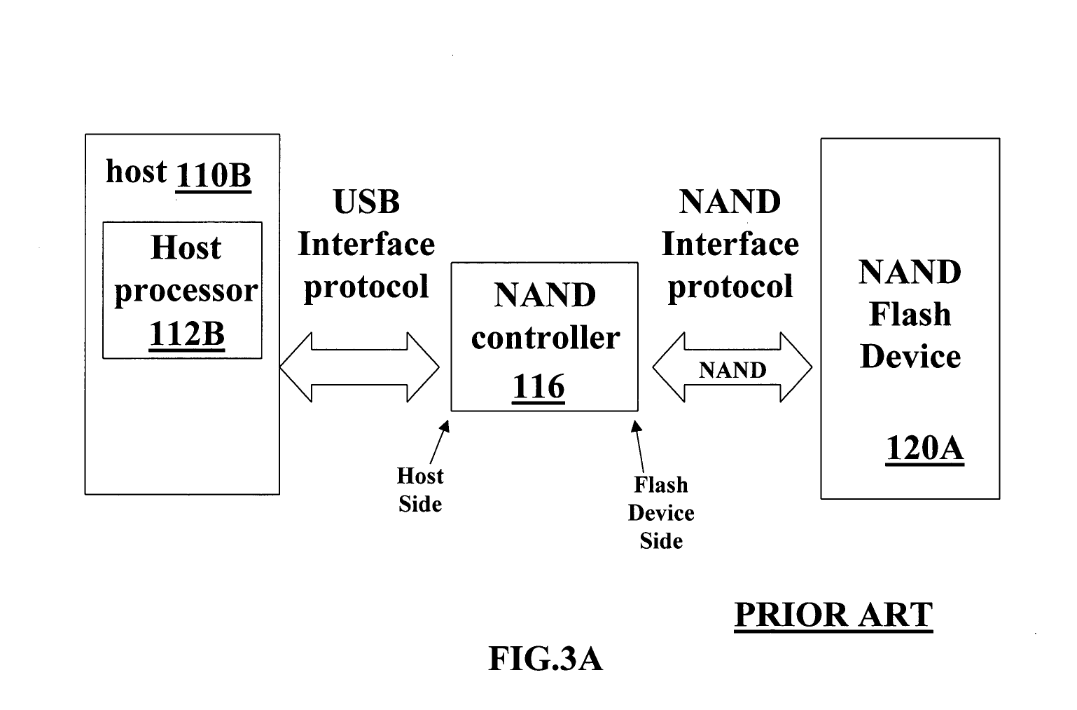

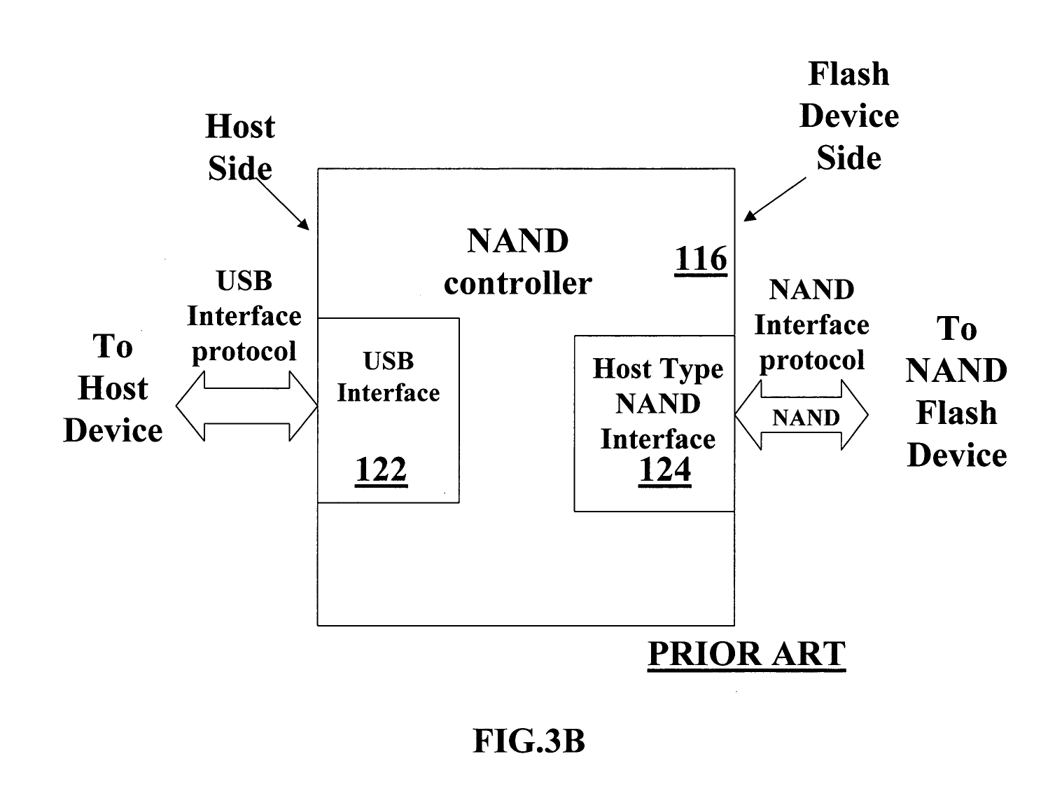

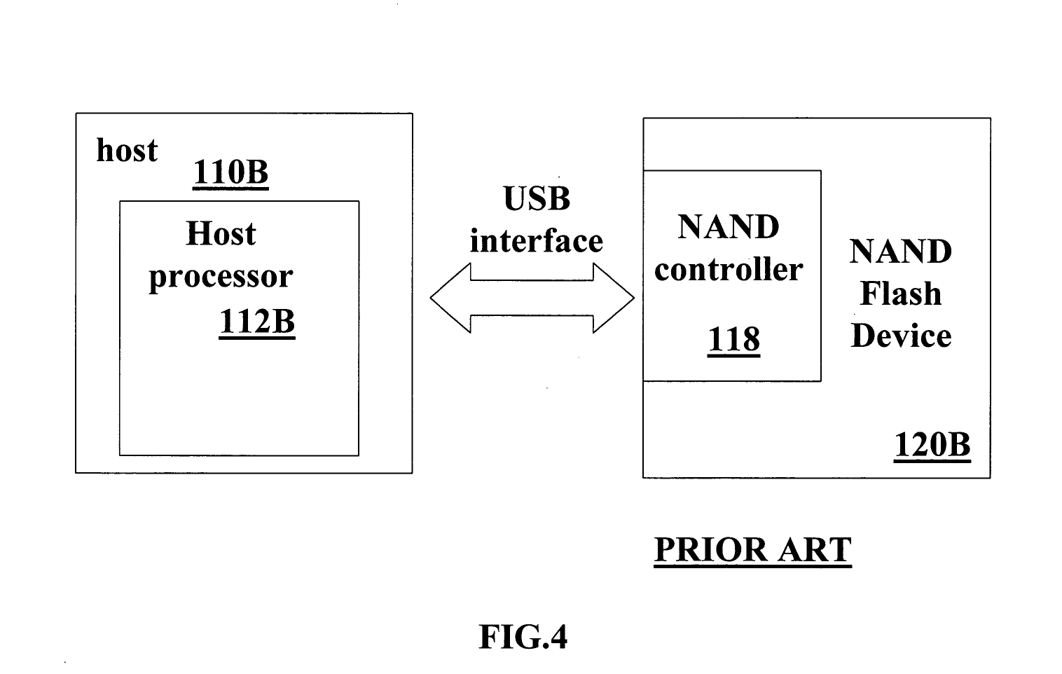

FIG. 5B is a schematic block diagram of an exemplary system including external NAND controller 130 (i.e. a controller separate from the host device) described in FIG. 5A. Through device side NAND interface 142, external NAND controller 130 interfaces with NAND flash device 120A of FIGS. 2 and 3A. Through host side NAND interface 144, NAND controller 130 interfaces with host device 110A of FIG. 2.

One innovative feature of the present invention is that controller 130 interacts with host 110A using sectors of data. Host 110A writes sectors to controller 130 and reads sectors from controller 130, in both cases using logical addresses. On the other side, controller 130 interacts with NAND flash memory device 120A using pages of data, where pages have different size than sectors.

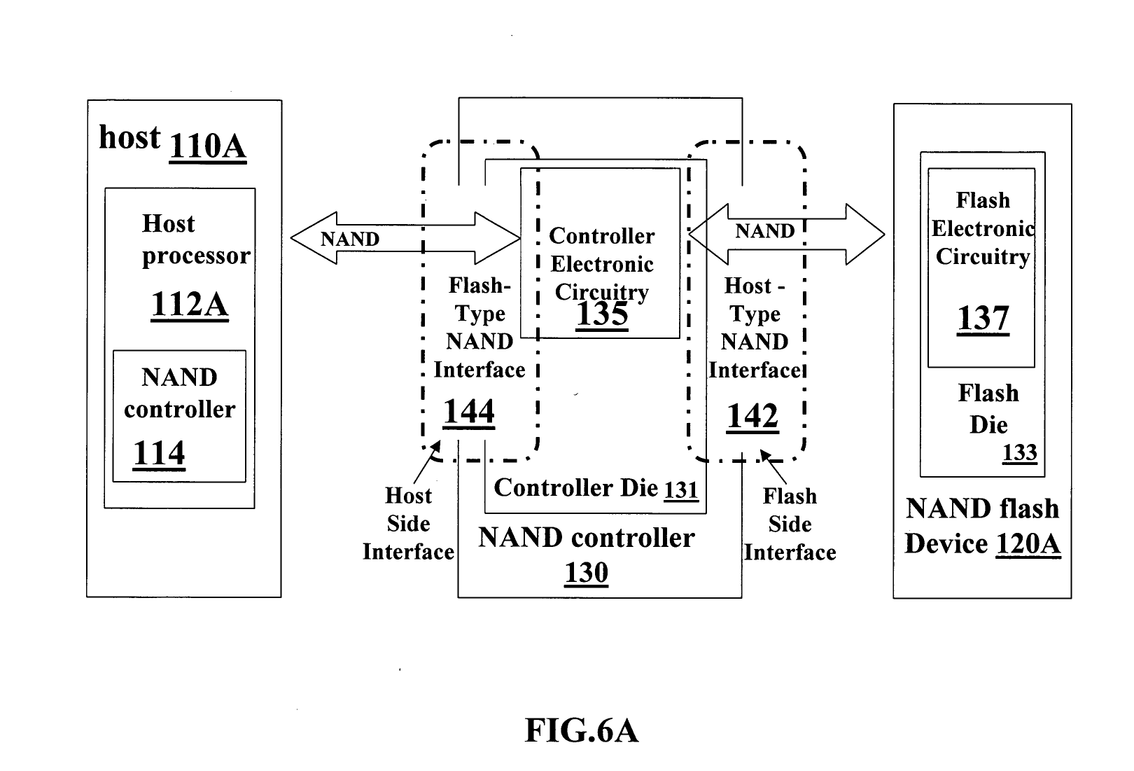

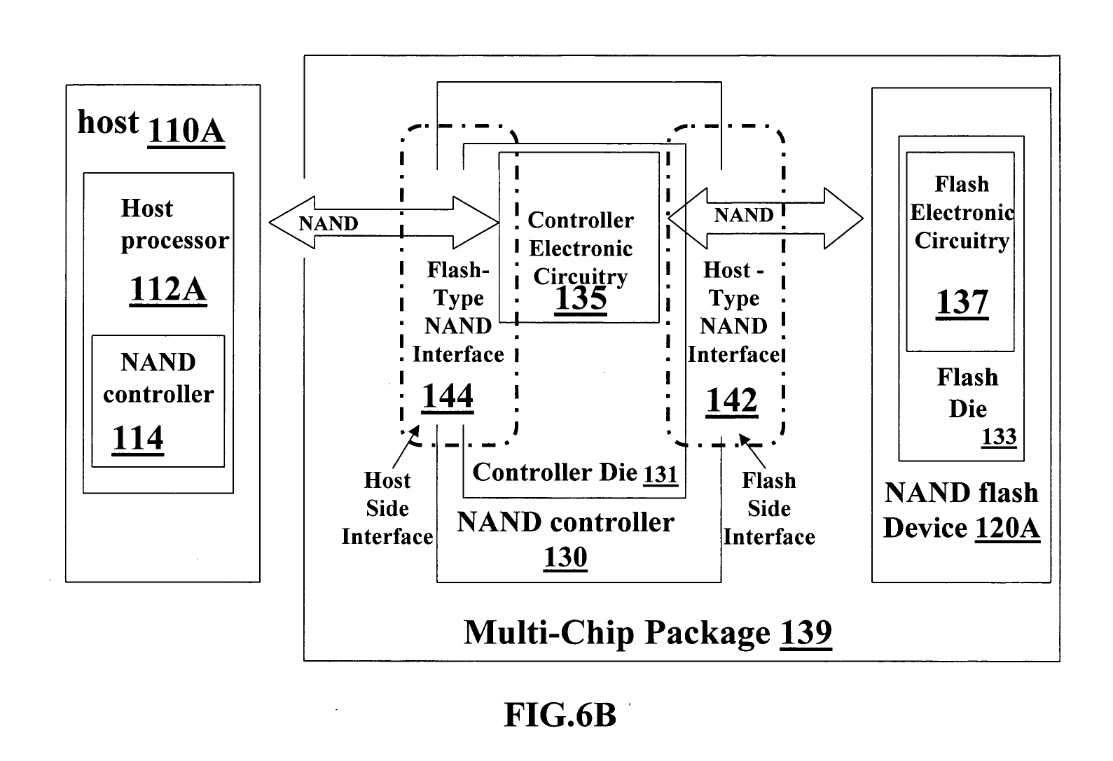

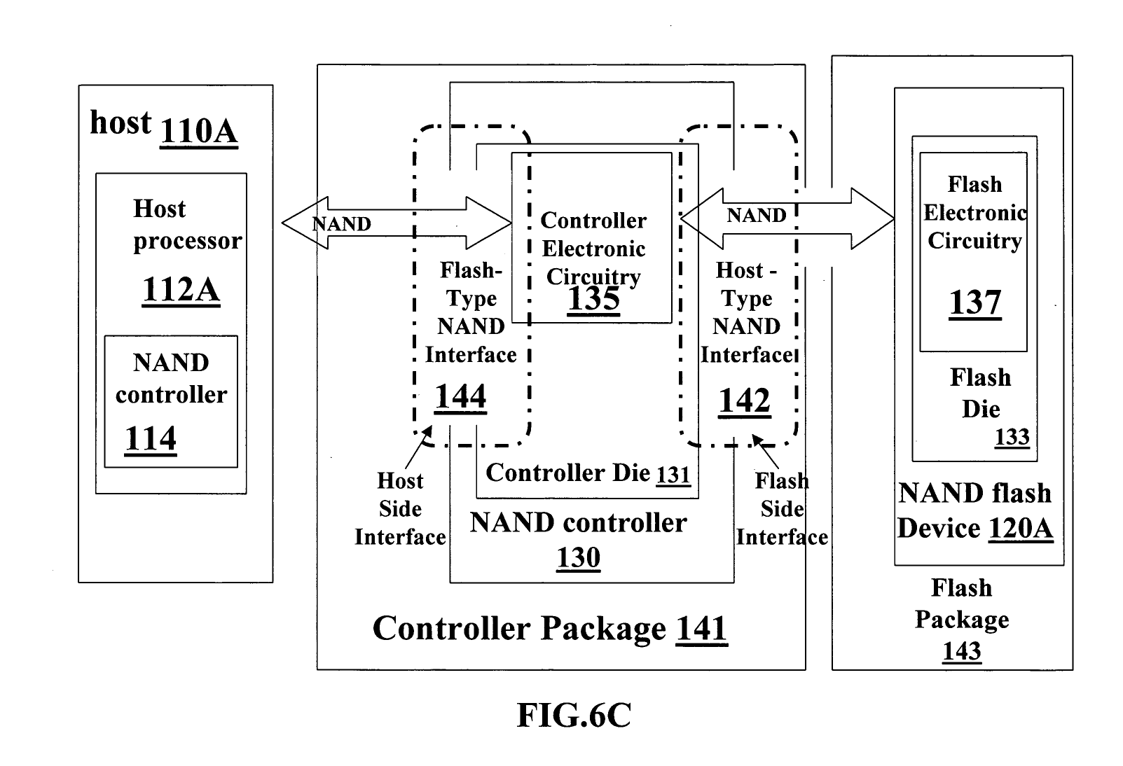

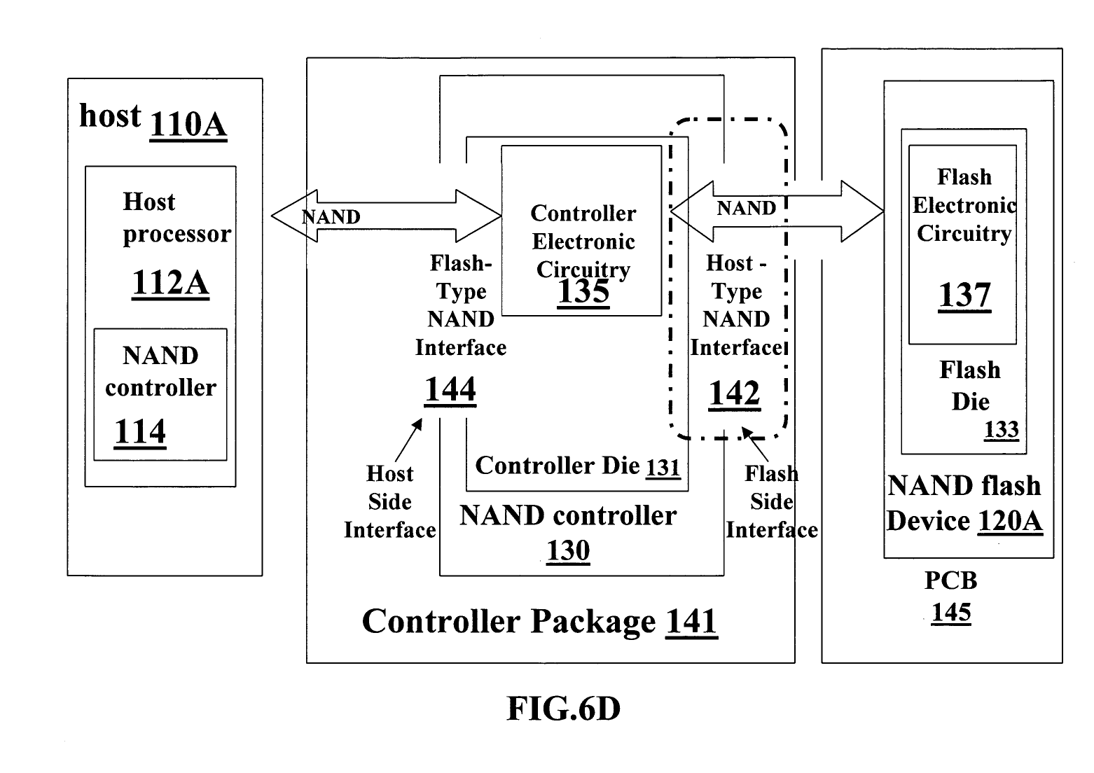

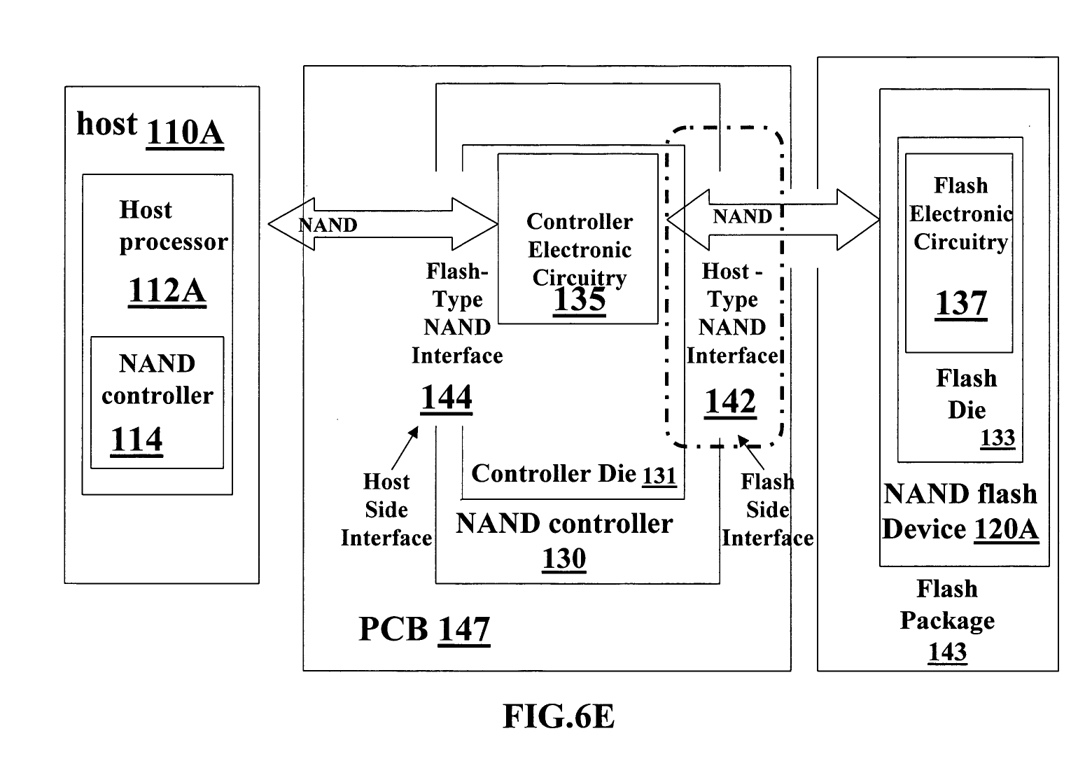

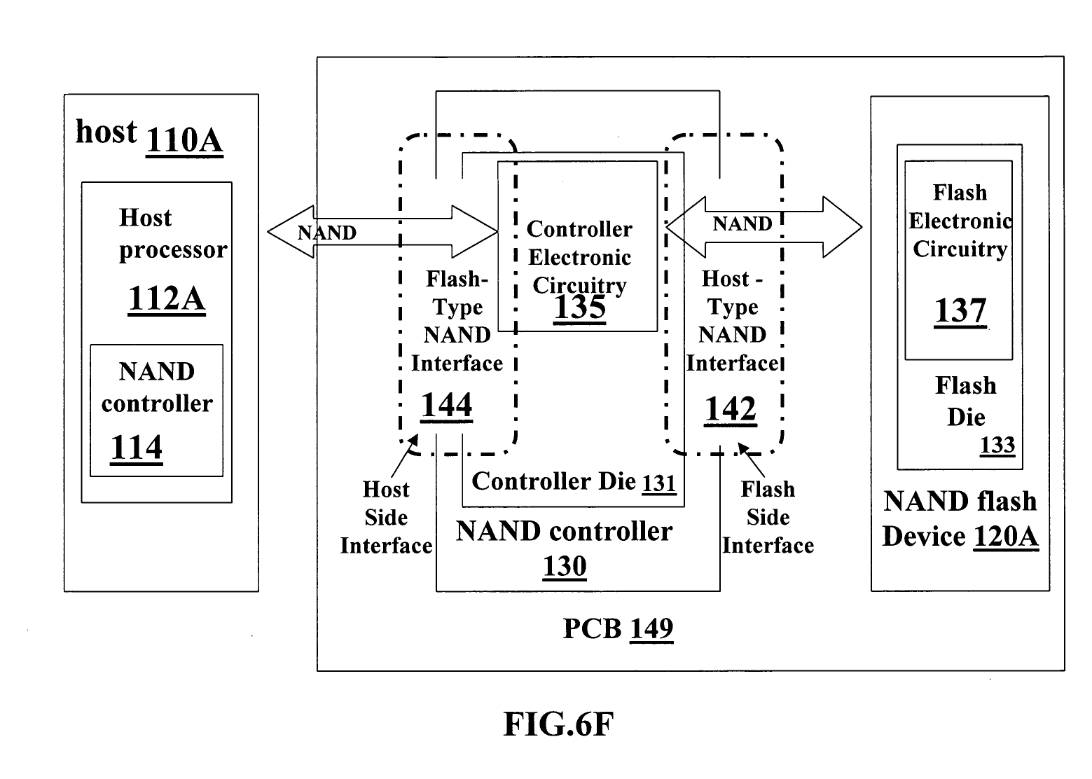

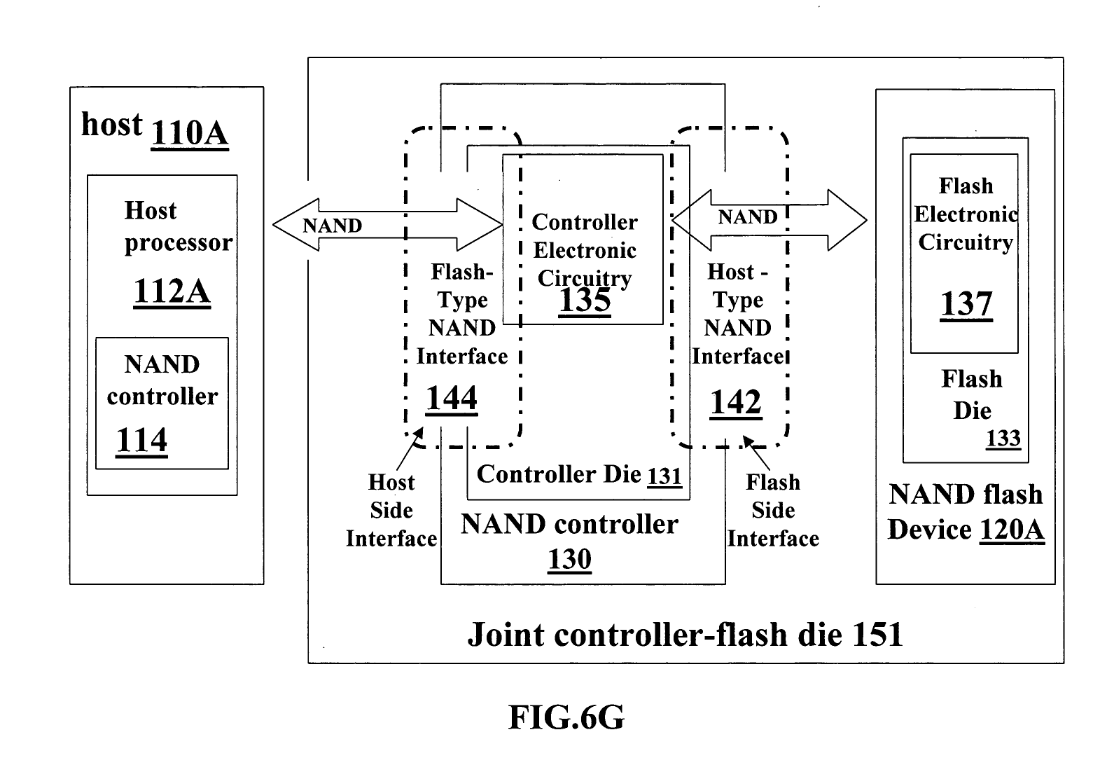

FIG. 6A shows an exemplary die configuration of the exemplary system 15 described in FIG. 5A. Thus, NAND controller 130 includes electronic circuitry 135 fabricated on a controller die 131 while NAND flash device 120A includes electronic circuitry 137 fabricated on a flash die 133. Controller die 131 and flash die 133 are distinct, separate dies.

It is noted that elements within NAND controller 130 as illustrated in FIG. 5A (i.e. ECC module 132, flash-type NAND interface 144, host-type NAND interfaces 144 and 146) are implemented at least in part by controller electronic circuitry 135 that resides on controller die 131.

Interface 142 between controller electronic circuitry 135 and flash electronic circuitry 137 is an “inter-die” interface. As used herein, an “inter-die interface” (e.g. an inter-die NAND interface) is operative to interface between two distinct units of electronic circuitry residing on distinct dies (e.g. to provide the necessary physical and logical infrastructure for the distinct units of electronic circuitry to communicate with each other, for example, using one or more specific protocols). Thus, inter-die interface 142 includes the necessary physical elements (pads, output and input drivers, etc) for interfacing between the two distinct units 135 and 137 of electronic circuitry residing on separate dies 130 and 133.

According to some embodiments of the present invention, an inter-die interface interfaces between electronic circuitry fabricated on two distinct dies that are packaged in a common package. This example is illustrated in FIG. 6B, wherein both NAND controller 130 and NAND flash device 120A reside within a common multi-chip package 139.

Alternatively, the inter-die interface interfaces between electronic circuitry fabricated on two distinct dies packaged in distinct packages (for example, where each die is packaged in its own package). This example is illustrated in FIG. 6C that shows NAND controller 130 and NAND flash device 120A residing in separate respective packages 141 and 143. NAND controller 130 resides within controller package 141, while NAND flash device 120A resides within flash package 143. Thus, as illustrated in FIG. 6C, interface 142 is an “inter-package interface.” The embodiments in which the dies reside in a common package (for example, as shown in FIG. 6B) and in which the dies reside in separate packages (for example, as shown in FIG. 6C) are not the only possible configurations.

Thus, alternatively, in some embodiments, the inter-die interface interfaces between electronic circuitry fabricated on two distinct dies, where one or both of these dies has no package at all. For example, in many applications, due to a need to conserve space, memory dies are provided (e.g. mounted, for example, directly mounted) on boards with no packaging at all. Thus, in one example, it is noted that in the new generation of memory cards for phones, memory dies are often mounted on boards with no packaging at all. As used herein, a die which is “directly mounted” onto a printed circuit board is mounted on the printed circuit board without being packaged first. These embodiments are illustrated in FIGS. 6D, 6E and 6F. FIG. 6D shows NAND controller 130 packaged in controller package 141, as in FIG. 6C, and NAND flash device 120A mounted directly on a printed circuit board 145. FIG. 6E shows NAND flash device 120A packaged in flash package 143, as in FIG. 6C, and NAND controller 130 mounted directly on a printed circuit board 147. FIG. 6F shows NAND controller 130 and NAND flash device 120A both mounted directly on a common printed circuit board 149.

Although it is typically the case that a NAND controller exporting a logical interface is implemented on a separate die from the NAND device that the controller controls, this is not essential for the present invention. Therefore, the present invention also is applicable when both the NAND device and the NAND controller are implemented on a common single die. FIG. 6G shows NAND controller 130 and NAND flash device 120A both fabricated on a common die 151.

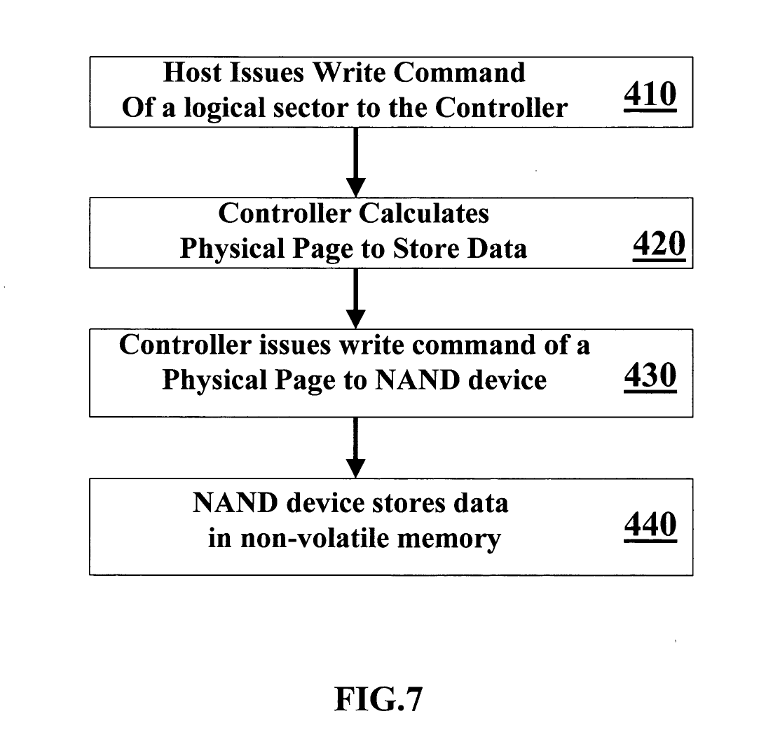

FIG. 7 is a flow chart of a method by which host 110A (i.e. a host that includes a NAND controller 114 within the device) writes data (e.g. a sector of data) to NAND storage device 120A via external NAND controller 130. As shown in FIG. 7, host 110A issues (block 410) a write command to the external controller 130 (e.g. a write command issued using the NAND interface protocol, including command bytes, address bytes and data bytes, where the command addresses a logical sector).

NAND controller 130 receives the logical sector write command issued by host 110A (e.g. via the host-side NAND interface 144). After receiving the write command, controller 130 calculates (block 420) a physical page number into which the sector data is to be stored. If needed, controller 130 may read previously stored sectors from NAND device 120A and merge the data of such sectors with the data of the newly received sector, thus generating the data that are to be written into the calculated physical page. Controller 130 then issues (block 430) a physical page write command to NAND device 120A (e.g. via flash memory device side interface 142). Again, the command is issued according to the NAND interface protocol, including command bytes, address bytes and data bytes. In block 440 NAND flash storage device 120A stores the data bytes it received into the non-volatile memory cells of the specified physical page, thus fulfilling the request of host 110A.

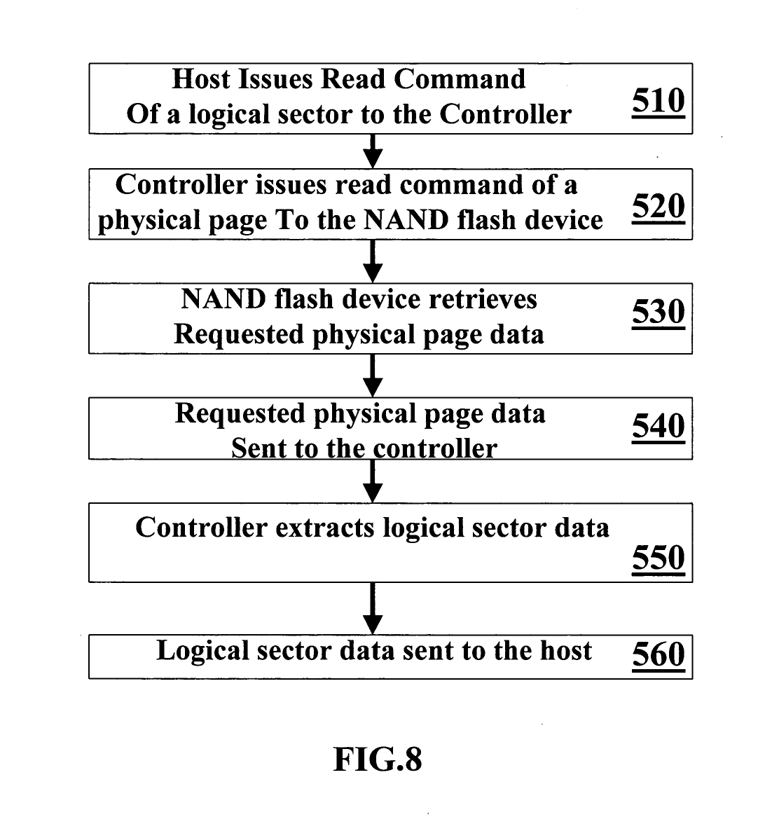

FIG. 8 is a flowchart of a method by which host 110A (i.e. a host that includes a NAND controller 114 within the device) reads data (e.g. a sector of data) from NAND storage device 120A via external NAND controller 130. Host 110A issues (block 510) a read command to external controller 130 (e.g. a read command issued using the NAND interface protocol, including command bytes and address bytes where the command addresses a logical sector).

External NAND controller 130 receives the logical sector read command issued by host 110A (e.g. via host-side NAND interface 144). After receiving the read command, external controller 130 issues (block 520) a physical page read command (e.g. via device-side NAND interface 142) to NAND device 120A. Again, the command is issued according to the NAND interface protocol, including command bytes and address bytes. The physical page address embedded in the command is calculated by controller 130 according to the logical sector address provided by host 110A in block 510, and according to mapping tables maintained by controller 130. In block 530 NAND flash storage device 120A retrieves the requested physical page data from its non-volatile cell array. In block 540 the data bytes are sent to external NAND controller 130. This sending is done according to the NAND interface protocol by a series of read strobes generated by controller 130, each read strobe sequentially reading into controller 130 one byte or one word (depending on whether the NAND interface used is 8 bits wide or 16 bits wide). Controller 130 may read all the data of the physical page, or controller 130 may selectively read only those data bytes corresponding to the requested logical sector. In block 550 external NAND controller 130 extracts the logical sector data from the physical page data. This is necessary only if controller 130 reads all of the data of the physical page in block 540. In block 560 the extracted data bytes of the logical sector are sent to host 110A via host side NAND interface 144. The sending is again done according to the NAND interface protocol by a series of read strobes generated by host 110A. Host 110A now has the same data bytes of the logical sector that host 110A originally stored into the flash memory.

A flash memory storage system, incorporating a flash memory device and a controller, and incorporating the methods of the present invention can be constructed in any of the following ways:

a. The memory system accepts only commands that manipulate logical sectors, and accepts no commands that manipulate logical pages.

b. The memory system accepts both commands that manipulate logical sectors and commands that manipulate logical pages. A mode-changing command switches the system between two modes—one mode for each type of command.

c. The memory system accepts both commands that manipulate logical sectors and commands that manipulate logical pages. One of the modes is the default mode, and a prefix before a command indicates that the command should be interpreted as a command of the non-default mode.

d. The memory system accepts both commands that manipulate logical sectors and commands that manipulate logical pages. An electrical signal applied to one of the system's contact pins at the time of power-up selects one of the two modes. For example, a “1” level at the selection pin indicates all commands should be understood to be sector-based commands, while a “0” level at the selection pin indicates all commands should be understood to be page-based commands.

e. The memory system accepts both commands that manipulate logical sectors and commands that manipulate logical pages. An electrical signal applied to one of the system's contact pins at runtime selects one of the two modes. For example, a “1” level at the selection pin indicates all commands executed at the current time should be understood to be sector-based commands, while a “0” level at the selection pin indicates all commands executed at the current time should be understood to be page-based commands.

For all of the above implementations in which both sector-based and page-based commands are supported in a system, the amount of data provided in a write command depends on whether the write command is a page command or a sector command. In other words, while a page-based write command includes for example the sending of 2 Kbytes of data, a sector-based write command includes for example the sending of just 0.5 Kbytes. Similarly, the amount of data the host may retrieve in a read command also depends on whether the read command is a page command or a sector command.

In all types of logical interfaces, regardless of whether the logical interfaces are sector-based or page-based, the only data provided by the host to the storage system is the user data. In other words, when a logical sector is being stored, exactly 512 bytes are sent by the host. This is contrary to physical NAND interfaces in which some additional data bytes are sometimes provided by the host and stored in an “extra” or “spare” area. Such bytes may contain control information, typically used for flash management algorithms. As logical interfaces put the burden of flash management on the memory system, the host is relieved of that task and need not bother with control information.

The structure of sector-based commands can be identical to the structure of page-based commands. The same opcodes for read and write commands may be used (opcodes 00H and 80H respectively). The logical sector address provided within a sector-based command corresponds to the page address provided within a page-based command. A sector-based command may also allow specifying a specific byte within the sector as a starting point, similar to the way a page-based NAND command allows specifying such starting point. This is however optional, and a system may implemented such that only complete sectors are written and read.

It can now be seen that the present invention allows one to benefit from a logical NAND interface even when the physical pages of a NAND device differ in size from the sectors of the host computer's operating system.

In the description herein and in the appended claims, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments include different features, not all of which are required in all embodiments of the invention. Some embodiments of the present invention utilize only some of the features or possible combinations of the features. Variations of embodiments of the present invention that are described and embodiments of the present invention including different combinations of features noted in the described embodiments will readily occur to those skilled in the art.

What is claimed is:

1. A controller for a flash memory device, comprising:
(a) a host-type NAND interface for exchanging data pages with the flash memory device; and
(b) a flash-type NAND interface for exchanging data sectors with a host of the controller;
wherein said data pages have a common data page size, and wherein said data sectors have a common data sector size different than said common data page size.

2. The controller of claim 1, wherein said common data sector size is smaller than said common data page size.

3. The controller of claim 1, wherein said host-type NAND interface is a physical interface and said flash-type NAND interface is a logical interface.

4. The controller of claim 1, further comprising:
(c) at least one other host-side interface.

5. The controller of claim 1, further comprising:
(c) an error correction module.

6. The controller of claim 1, further comprising:
(c) an encryption module.

7. The controller of claim 1, further comprising:
(c) an address mapping module.

8. A data storage system comprising:
(a) the controller of claim 1; and
(b) the flash memory device of claim 1.

9. The data storage system of claim 8, wherein the flash memory device is a NAND flash memory device.

10. The data storage system of claim 8, wherein the controller and the flash memory device are fabricated on different respective dies and wherein said host-type NAND interface is an inter-die interface.

11. The data storage system of claim 10, further comprising:
(c) a multi-chip package wherein the controller and the flash memory device are packaged.

12. The data storage system of claim 10, further comprising:
(c) a controller package for packaging the controller.

13. The data storage system of claim 12, further comprising:
(d) a memory device package, separate from said controller package, for packaging the flash memory device.

14. The data storage system of claim 12, further comprising:
(d) a printed circuit board whereon said die, whereon the flash memory device is fabricated, is directly mounted.

15. The data storage system of claim 10, further comprising:
(c) a memory device package for packaging the flash memory device.

16. The data storage system of claim 15, further comprising:
(d) a printed circuit board whereon said die, whereon the controller is fabricated, is directly mounted.

17. The data storage system of claim 10, further comprising:
(c) a printed circuit board whereon said dies are directly mounted.

18. The data storage system of claim 8, wherein the controller and the flash memory device are fabricated on a common die.

19. A data processing system comprising:
(a) the data storage system of claim 8; and
(b) a host of the data storage system of claim 8.

20. A data storage system comprising:
(a) a memory that includes a plurality of physical pages having a common physical page size; and
(b) circuitry for exporting a flash-type NAND interface for exchanging data sectors with a host of the data storage system, wherein said data sectors have a common data sector size different than said physical page size.

21. The data storage system of claim 20, wherein said common data sector size is smaller than said common physical page size.

22. The data storage system of claim 20, wherein said flash-type NAND interface is a logical interface.

23. The data storage system of claim 20, wherein each said page includes a plurality of flash cells.

24. The data storage system of claim 23, wherein said flash cells are NAND flash cells.

25. The data storage system of claim 20, wherein said memory and said circuitry are fabricated on separate respective dies.

26. The data storage system of claim 25, further comprising:
(c) a multi-chip package wherein said memory and said circuitry are packaged.

27. The data storage system of claim 25, further comprising:
(c) a circuitry package for packaging said circuitry.

28. The data storage system of claim 27, further comprising:
(d) a memory package, separate from said circuitry package, for packaging said memory.

29. The data storage system of claim 27, further comprising:
(d) a printed circuit board whereon said die, whereon said memory is fabricated, is directly mounted..

30. The data storage system of claim 25, further comprising:
(c) a memory package for packaging said memory.

31. The data storage system of claim 30, further comprising:
(d) a printed circuit board whereon said die, whereon said circuitry is fabricated, is directly mounted.

32. The data storage system of claim 25, further comprising:
(c) a printed circuit board whereon said dies are directly mounted.

33. The data storage system of claim 20, wherein said memory and said circuitry are fabricated on a common die.

34. A data processing system comprising:
(a) the data storage system of claim 20; and
(b) a host of the data storage system of claim 20.
